(19) United States
(12) Patent Application Publication
(10) Pub. No.: US 2019/0246669 A1
(43) Pub. Date: Aug. 15, 2019

(54) SYSTEMS AND METHODS FOR BLENDING LOW SOLUBILITY INGREDIENTS

(71) Applicant: The Coca-Cola Company, Atlanta, GA (US)

(72) Inventors: Anish Mehta, Alpharetta, GA (US); Hubertus Ulrich Schubert, Atlanta (DE); Mamunur Rahman, Smyrna, GA (US); Shumi Baker, Marietta, GA (US)

(73) Assignee: The Coca-Cola Company, Atlanta, GA (US)

(21) Appl. No.: 16/343,454

(22) PCT Filed: Oct. 20, 2017
(86) PCT No.: PCT/US2017/057678

§ 371 Date: Apr. 19, 2019

Related U.S. Application Data
(60) Provisional application No. 62/410,905, filed on Oct. 21, 2016.

(51) Int. Cl. A23L 2/60

(52) U.S. Cl. CPC A23L 2/60; A23V 2002/00; A23V 2300/31; A23V 2200/132; A23V 2250/258

(57) ABSTRACT

Systems and methods for blending low solubility ingredients are provided. In one embodiment, a method of blending a low solubility ingredient into a beverage solution includes dissolving the low solubility ingredient in a preselected solvent to provide a first solution. In one embodiment, the preselected solvent is preheated. The method also includes mixing various ingredients from one or more pre-blend batches to form a beverage syrup and mixing the first solution with the beverage syrup to form the beverage solution.

### CROSS-REFERENCE TO RELATED APPLICATIONS

This application claims the benefit of priority to U.S. Provisional Application No. 62/410,905, filed Oct. 21, 2016, which is incorporated herein by reference in its entirety.

### FIELD OF THE INVENTION

The present disclosure relates to methods of mixing low solubility ingredients, particularly for use in beverages.

### BACKGROUND

Consumers are increasingly looking for low-calorie and zero-calorie beverage options, and particularly are seeking low-calorie and zero-calorie beverages made from natural ingredients, such as beverages sweetened with stevia and steviol glycosides derived from stevia. However, many low-calorie and zero-calorie sweeteners used in such beverages have low solubilities in water, so that conventional full calorie sweeteners must typically be used in conjunction with these low-solubility natural sweeteners to provide a beverage which has acceptable sweetness.

Low-solubility ingredients, such as low-solubility sweeteners, create difficulties in conventional beverage creation processes, such as those employed at bottling plants, and in post-mix dispensing systems. For example, low-solubility ingredients may precipitate out of beverage solutions, resulting in equipment failure and downtime in bottling plants and post mix dispensers, and in shorter shelf life for commercial beverages.

Accordingly, improved systems and methods for blending low-solubility ingredients into beverages are desired.

### SUMMARY

This summary is provided to introduce various concepts in a simplified form that are further described below in the detailed description. This summary is not intended to identify required or essential features of the claimed subject matter nor is the summary intended to limit the scope of the claimed subject matter.

This summary and the following detailed description provide examples and are explanatory only of the invention. Accordingly, the foregoing summary and the following detailed description should not be considered to be restrictive. Additional features or variations thereof can be provided in addition to those set forth herein, such as for example, various feature combinations and sub-combinations of these described in the detailed description.

Among other things, this disclosure provides a method of blending a low solubility ingredient into a beverage solution comprising: dissolving the low solubility ingredient in a preheated solvent to provide a first solution; combining one or more pre-blend batches to form a beverage syrup; and combining the first solution with the beverage syrup to form a beverage solution. In one aspect, the step of dissolving the low solubility ingredient in a preselected solvent to provide the first solution can comprises: combining the low solubility ingredient with the preheated solvent to provide the first solution wherein the preheated solvent has a first temperature; and cooling the first solution to a second temperature while stirring the first solution. By way of example, the first solution can be formed using a preheated solvent that is preheated to a first temperature that is any temperature above ambient temperature, for example from about 20° C. to about 80° C., from about 30° C. to about 70° C., from about 40° C. to about 70° C., or from about 55° C. to about 70° C.

In another aspect, this disclosure also provides a method of blending a low solubility ingredient into a beverage solution comprising: combining the low solubility ingredient with a preheated solvent in a first tank to provide a first solution wherein the preheated solvent has a first temperature; cooling the first solution to a second temperature to form a cooled solution while stirring the first solution; transferring the cooled solution to a second tank; combining the cooled solution with a second solvent to form a second solution; transferring the second solution to a buffer tank; combining one or more pre-blend batches to form a beverage syrup; and combining the second solution with the beverage syrup to form a beverage solution. Various mixing apparatuses configured to facilitate blending of a low solubility ingredient into a beverage solution are also disclosed.

### BRIEF DESCRIPTION OF THE DRAWINGS

The following figures form part of the present specification and are included to further demonstrate certain aspects of the present disclosure. The invention may be better understood by reference to one or more of these figures in combination with the detailed description of specific aspects presented herein.

FIG. 1 illustrates an example manufacturing process which can be improved using one or more embodiments of low solubility ingredient blending;

FIG. 2 illustrates an example manufacturing process in which embodiments of low solubility ingredient blending can be employed;

FIG. 3 illustrates an example system in which embodiments of low solubility ingredient blending can be employed;

FIG. 4 illustrates an example system in which embodiments of low solubility ingredient blending can be employed;

FIG. 5 illustrates an example system in which embodiments of low solubility ingredient blending can be employed;

FIG. 6 illustrates an example system in which embodiments of low solubility ingredient blending can be employed;

FIG. 7 illustrates example specifications for elements of example manufacturing processes in which embodiments of low solubility ingredient blending can be employed;

FIG. 8 illustrates example specifications for elements of example manufacturing processes in which embodiments of low solubility ingredient blending can be employed; and

FIG. 9 illustrates an example computing device that can be used in accordance with various embodiments of low solubility ingredient blending.

FIG. 10 illustrates an example manufacturing process including a system for preblending low solubility ingredients.

FIG. 11 illustrates an example manufacturing process including a system for preblending low solubility ingredients.

FIG. 12 is a graph of the concentration of Reb M over time from portions of a pilot test Reb M solution.

FIG. 13 is a graph of the concentration of Reb M over time from portions of a pilot test Reb M solution.

FIG. 14 is a graph of the concentration of Reb M over time from portions of a pilot test Reb M solution.

### DETAILED DESCRIPTION

In the following description, numerous details are set forth to provide an understanding of some embodiments of the present disclosure. However, it will be understood by those of ordinary skill in the art that systems and methodologies may be practiced without these details and that numerous variations or modifications from the described embodiments may be possible.

Additionally, it will also be understood that the term “optimize” as used herein can include any improvements up to and including optimization. Similarly, the term “improve” can include optimization. Other terms like “minimize” and “maximize” can also include actions reducing and increasing, respectively, various quantities and qualities.

As used herein, “low-solubility ingredient,” abbreviated as “LSI,” is used broadly to refer to any substance which has a low or limited solubility in a solvent. These low solubility ingredients may include highly viscous fluids such as different types of viscous sweeteners or different types of solids such as non-crystalline or crystalline solids. Generally described, low solubility ingredients may have unstable properties in solution, i.e., the ingredients may precipitate out of solution, change viscosity, crystallize, and the like. In one aspect, for example, such low solubility ingredients may have a solubility in water at ambient temperature of three weight percent (3 wt %) or less and in some instances may have a solubility of two weight percent (2 wt %) or less, or a solubility of one weight percent (1 wt %) or less. In another aspect, for example, a low-solubility ingredient in water includes any ingredient with a solubility of less than 0.5 wt % of the ingredient in water at 20° C., less than 0.2 wt %, less than 0.1 wt %, less than 0.05 wt %, less than 0.02 wt %, less than 0.01 wt %, less than 0.005 wt %, less than 0.002 wt %, or a solubility of less than 0.001 wt % in water at 20° C. Some examples of low solubility ingredients for a beverage dispenser may include sorbic acid, caffeine, Reb A, Reb D, Reb M, Reb M80, A95, and other steviol glycosides.

As used herein, “high shear mixing” is used broadly to refer to forms of mixing which disperse or transport a low-solubility ingredient into a solvent.

As used herein, mixing can be stirring, agitating, shaking, or any other suitable manner of combining ingredients. In preferred embodiments, mixing is high shear mixing.

As used herein, a solution including a low solubility ingredient is “stable” at a particular time and temperature if the low solubility ingredient does not precipitate out of solution after the specified amount of time when stored at the specified temperature. For example, an indication that a low solubility ingredient is stable after 3 days at ambient temperature means that the solution, when stored at ambient temperature for 3 days, did not result in visible precipitate of the low solubility ingredient. In some embodiments, a sample is stable if, after the specified period of time, samples taken from the top and bottom of a sample container exhibit a concentration of the low solubility ingredient which is within +/−10% of each other.

As used herein, “ambient temperature” is used broadly to refer to a range of temperatures which are typical of an ambient indoor environment. For example, ambient temperature may include temperatures of from about 60° F. to about 80° F., temperatures of from about 65° F. to about 75° F., and any temperatures therebetween.

When describing a range of temperatures, percentages, and the like, it is the Applicant's intent to disclose every individual number that such a range could reasonably encompass, for example, every individual number that has at least one more significant figure than in the disclosed end points of the range. As an example, when referring to a weight percentage as between 0.4 wt % and 1.2 wt %, it is intended to disclose that the weight percentage can be 0.4 wt %, 0.5 wt %, 0.6 wt %, 0.7 wt %, 0.8 wt %, 0.9 wt %, 1.0 wt %, 1.1 wt %, or 1.2 wt %, including any subranges or combinations of subranges encompassed in this broader range. Applicant's intent is that these two methods of describing the range are interchangeable. Moreover, when a range of values is disclosed or claimed, Applicant also intends for the disclosure of a range to reflect, and be interchangeable with, disclosing any and all sub-ranges and combinations of sub-ranges encompassed therein. Accordingly, Applicant reserves the right to proviso out or exclude any individual members of any such group, including any sub-ranges or combinations of sub-ranges within the group, or any selection, feature, range, element, or aspect that can be claimed, if for any reason Applicant chooses to claim less than the full measure of the disclosure, for example, to account for a reference that Applicant may be unaware of at the time of the filing of the application. In addition, the ranges set forth herein include their endpoints unless expressly stated otherwise. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. The scope of the invention is not limited to the specific values recited when defining a range.

The term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. The term “about” also encompasses amounts that differ due to different equilibrium conditions for a composition resulting from a particular initial mixture. Whether or not modified by the term “about”, the claims include equivalents to the quantities. The term “about” may mean within 10% of the reported numerical value, preferably within 5% of the reported numerical value.

Certain features of the disclosure which are, for clarity, described herein in the context of separate embodiments, may also be provided in combination in a single embodiment. Conversely, various features of the invention that are, for brevity, described in the context of a single embodiment, may also be provided separately or in any sub-combination.

Systems and Methods for Blending Low-Solubility Ingredients into Beverage Solutions

In some embodiments, various techniques and technologies associated with low solubility ingredient blending can be used to, for example, enable the blending of low solubility ingredients into beverages.

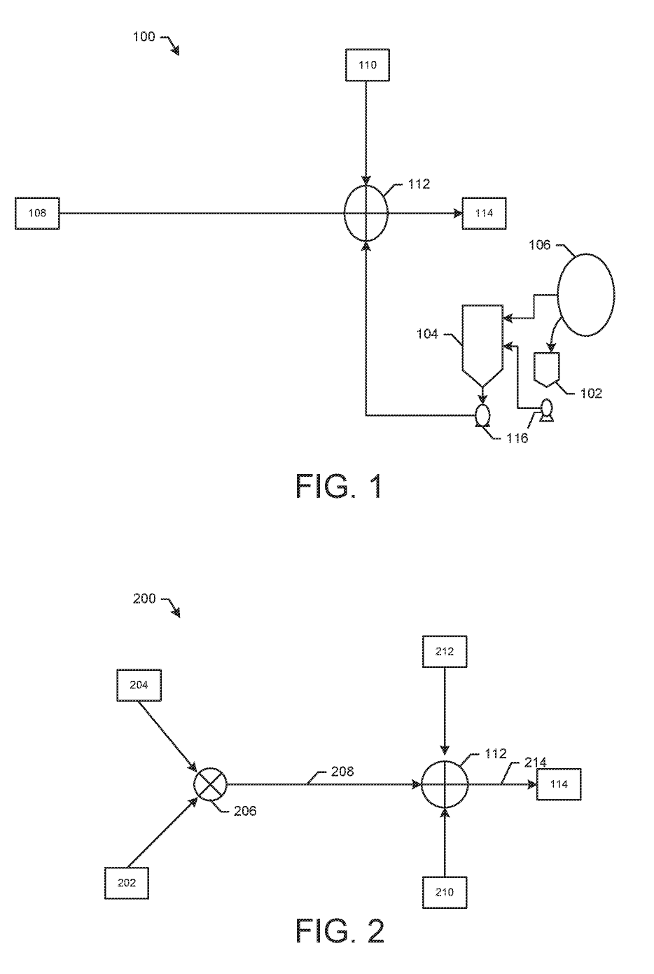

FIG. 1 illustrates a manufacturing process 100 which can be improved using one or more embodiments of low solubility ingredient blending. As illustrated, all ingredients for a beverage solution, including sweeteners, are blended in one or more preblend tanks 102 before being transferred to a syrup tank 104 for blending into a finished syrup. Preblend tanks 102 and syrup tank 104 can be of any size, construction, etc., known in the art.

In one embodiment, several runs with various ingredients can be conducted in the one or more preblend tanks 102, such that mixed ingredients can be added one after the other from the one or more preblend tanks 102 to syrup tank 104 where all the ingredients are ultimately collected and blended with water, such as treated water 106, to form a sweetened syrup. In some embodiments, a series of single ingredients may be mixed with treated water 106 in the preblend tanks 102 to form a series of preblends, which are added to the syrup tank 104 and mixed to form a beverage syrup.

The sweetened syrup can then be mixed with additional water, such as treated water 108 and CO₂ 110 at a proportioner-carbonator 112 before being conveyed to a filler 114. Proportioner-carbonator 112 can take any form known in the art and can comprise any equipment known in the art.

In one embodiment, treated water 106 is added to a syrup batch in syrup tank 104 in accordance with a desired formula. Moreover, in one possible embodiment, once the syrup batch is complete (i.e. all ingredients from the one or more preblend tanks 102 and the treated water 106 have been appropriately mixed in syrup tank 104) the syrup batch is transmitted to proportioner-carbonator 112. In yet another possible embodiment, treated water 108 can be 4-5 times the volume of the syrup batch (i.e. 4-5 parts treated water 108 can be mixed with one part syrup batch from syrup tank 104 at proportioner-conditioner 112). Moreover, it will be understood that the various fluids and mixtures in manufacturing process 100 can be moved among the various elements of manufacturing process 100 using any equipment and/or techniques known in the art, including, for example, one or more pumps 116 located at various positions in manufacturing process 100. Pumps 116 can include any pumps known in the art including, for example, metering pumps, positive displacement pumps, gear pumps, piston pumps, diaphragm pumps, etc. Moreover, it will be understood that in some embodiments pumps 116 may operate in conjunction with one or more flow control valves.

In some embodiments, example manufacturing process 100 may experience difficulties in mixing low solubility ingredients into the syrup batch in syrup tank 104.

For example, in one possible embodiment, the limited solubility of steviol glycoside (SG) derivatives such as Reb-M80 Crystalline (“crystalline Reb-M80”), which typically has a solubility limit of from about 0.1 w/w % to about 0.15%-w/w % in water, can pose limitations on the ability of such sweeteners to be effectively blended in the one or more preblend tanks 102 and syrup tank 104 in example manufacturing process 100. For instance, in one possible aspect, it may be desired to have a final beverage concentration of Reb-M 80 Crystalline of 100 parts per million (ppm) for a mid-calorie beverage, and 460 ppm for a zero calorie beverage. To achieve such final beverage concentrations in manufacturing process 100, Reb-M 80 Crystalline concentrations of 0.7-5%-w/w % in water may be experienced in the one or more preblend tanks 102. Similarly Reb-M 80 Crystalline concentrations of 0.25-0.3%-w/w % in water may be experienced in syrup tank 104. These concentrations are over the water solubility limit of Reb-M 80 Crystalline, and as a consequence, Reb-M 80 Crystalline may precipitate out of solution during manufacturing process 110 before arriving at filler 114.

FIG. 2 illustrates an example manufacturing process 200 in which embodiments of low solubility ingredient blending can be employed. As illustrated, one or more low solubility ingredients (LSIs) 202 can be mixed with a solvent 204 (such as treated water 108 or any other desirable solvent known in the art) at a first mixer 206 to provide or create a first solution 208. Low solubility ingredients (LSIs) can include anything having low and/or limited solubility including, for example, sweeteners such as stevia derivatives and/or steviol glycoside derivatives (such as Reb M/A95, Reb-M80, etc.), etc.

Beverage syrup 210 may be created by mixing a variety of ingredients at the one or more preblend tanks 102 and syrup tank 104, as described above. The beverage syrup 210 can then be mixed with the first solution and any carbonating agent 212 known in the art (including CO₂) at any carbonation concentration desired, at proportioner-carbonator 112 to create a beverage solution 214 which is transmitted to filler 114. In some embodiments, the variety of ingredients mixed at the one or more preblend tanks 102 does not include LSIs. In other embodiments, low levels of LSIs may be present in the variety of ingredients mixed at the one or more preblend tanks 102. Moreover, beverage syrup 210 can include any syrup known in the art, including for example, unsweetened syrups, non-additionally sweetened syrups, etc.

In one embodiment, LSIs 202 may be in solution with any desired solvent (including water such as treated water 108 and/or treated water 106) before being mixed with solvent 204 at first mixer 206. Moreover, in one aspect, in order to increase solubility, the solvent and/or resulting solution with LSIs 202 may be heated to any temperature desired. Solvent 204, LSIs 202, beverage syrup 210 and carbonating agent 212 can be mixed in any proportions desired, and at any temperatures desired. Plus it will be understood that beverage syrup 210 may include sweeteners including some LSIs 202.

In one possible embodiment, LSIs 202 can be dissolved in water at approximately 1,000 ppm at approximately 55 degrees Celsius. This solution then can be mixed with solvent 204 (at any desired temperature, including for example, from 22-26 degrees Celsius) at first mixer 206 at an approximate ratio of 8 parts solvent to one part of the LSI solution, resulting in first solution 208 having approximately 592 ppm of LSIs with an approximate temperature of 27 degrees Celsius, for example.

First solution 208 can then be blended with beverage syrup 210 and carbonating agent 212 at proportioner-carbonator 112 (with a throw ratio of 5:1, for example) to create beverage solution 214 with a concentration of LSIs of 500 ppm.

It will be understood that example manufacturing process 200 can be implemented using any equipment known in the art in any desired configuration(s), including through the use of various skids.

In one possible embodiment, various types of blend-in skids can configured to dissolve LSIs 202 independently (including in warm water) and mix LSIs 202 directly into an ingredient treated water stream such as the stream of solvent 204.

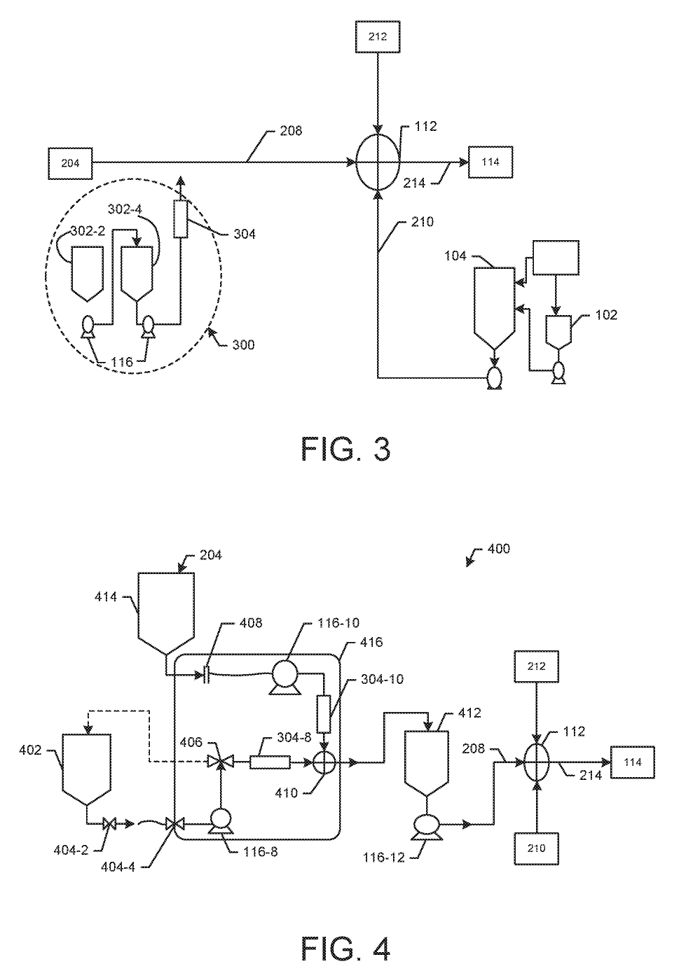

FIG. 3 illustrates a manufacturing process 200 in which embodiments of low solubility ingredient blending can be employed. As illustrated, a blend-in system 300 is tied into the various processes present in example manufacturing process 100 such that the LSIs 202 are added into solvent 204 (such as treated water 108 in FIG. 1) rather than having LSIs 202 be exclusively added in the one or more preblend tanks 102 (though it will be understood that some LSIs may be still added into the one or more preblend tanks 102 if desired).

Blend-in system 300 may include one or more blending tanks 302 (illustrated as 302-2 and 302-4) of any volume, build and/or configuration known in the art. Moreover, blend-in system 300 may include one or more pumps 116 of any type known in the art to transmit LSIs 202 in solution from the one or more blending tanks 302 to a stream including solvent 204. In one embodiment, one or more concentration meters 304 may be present at various locations in blend-in system 300 to measure and control a concentration of LSIs 202 in solution in blend-in system 300. Concentration meters 304 can include any types of meters capable of measuring flow and/or weight of LSIs 202 in a solution, and can include, for example, flow meters, load cells, mass flow meters, etc.

For example, if one or more of the concentration meters 304 measure a concentration of LSIs 202 in solution near, at, and/or above a preset limit (such as a solubility limit of the LSIs 202, for example) a warning signal can be sent to a control system, which can issue commands to lean out the concentration of LSIs being added into blend-in system 300 (and/or increase the amount of solvent [such as solvent 204] in which LSIs 202 are in solution in blend-in system 300 and outside of blend-in system 300) to avoid any problems, such as, for example, precipitation of LSIs 202 out of solution both in and out of system 300.

FIG. 4 illustrates another embodiment of manufacturing process 200 in system 400 in which embodiments of low solubility ingredient blending can be employed. As illustrated, a batch tank 402 can be used to introduce LSIs to solvent 204 via a variety of shut off valves 404, 3 way valves 406, flanges 408 and a static mixer 410. Any number of shut off valves 404, 3 way valves 406, flanges 408 and static mixers 410 can be used, and any types of such equipment known in the art can be employed. In one possible aspect, two or more concentration meters 304 can be employed before a static mixer 410 and a buffer tank 412 to measure and control a concentration of LSIs 202 in solution in system 400, including in a manner similar to that described above in conjunction with FIG. 3.

Solvent 204 can be held in a solvent tank 414 of any size, build, and/or construction known in the art. In one possible aspect, solvent tank 414 can be a 2500 liter tank. Similarly, batch tank 402 can be of any size, build, and/or construction known in the art. In one possible aspect, batch tank 402 can be a 300 liter tank.

In one embodiment LSIs 202 can include Reb A and system 400 can create beverage solution 214 with a Reb A concentration of 500 ppm. In another embodiment, with LSIs 202 including Reb M80, system 400 can create a beverage solution 214 with a Reb M80 concentration of 500 ppm. In another embodiment, with LSIs 202 including A95, system 400 can create a beverage solution 214 with a zero calorie level with an A95 concentration of 500 ppm.

In one embodiment, some of the functionality used to introduce and/or blend LSIs 202 into the stream of solvent 204 can be termed a blend-in skid 416.

In one embodiment, a concentrated solution of LSIs 202 may be drawn from batch tank 402 through opened shut off valves 404-2, 404-4 by, for example, pump 116-8. The concentrated solution of LSI's 202 can be measured by meter 304-8 before arriving at static mixer 410. In one possible aspect, one or more of shut off valves 404-2 and 404-4 can be closed while batch tank 402 is being filled with LSIs 202 in solution (i.e. while LSIs 202 are mixed with a desired solvent at a desired concentration below the solubility limit of the LSIs in the solvent).

A three way valve 406 can be used to redirect a portion, if desirable, of the concentrated solution of LSIs 202 back to batch tank 402.

Similarly, solvent 204 may be drawn from solvent tank 414 through flange 408 by, for example, pump 116-10. (Regarding reference numbers, reference 116 illustrates or refers to a pump generally, and specific pumps may be numbered with a particular reference such as 116-10 or similarly throughout the specification and figures.) Solvent 204 can be measured by meter 304 before arriving at static mixer 410 where solvent 204 and the concentrated solution of LSIs 202 are mixed to create first solution 208 which may be pumped to buffer 412. First solution 208 can then be drawn by, for example, pump 116-12 to proportioner-carbonator 112 where it is mixed with beverage syrup 210 and carbonating agent 212 to form beverage solution 214 which is pumped to filler 114.

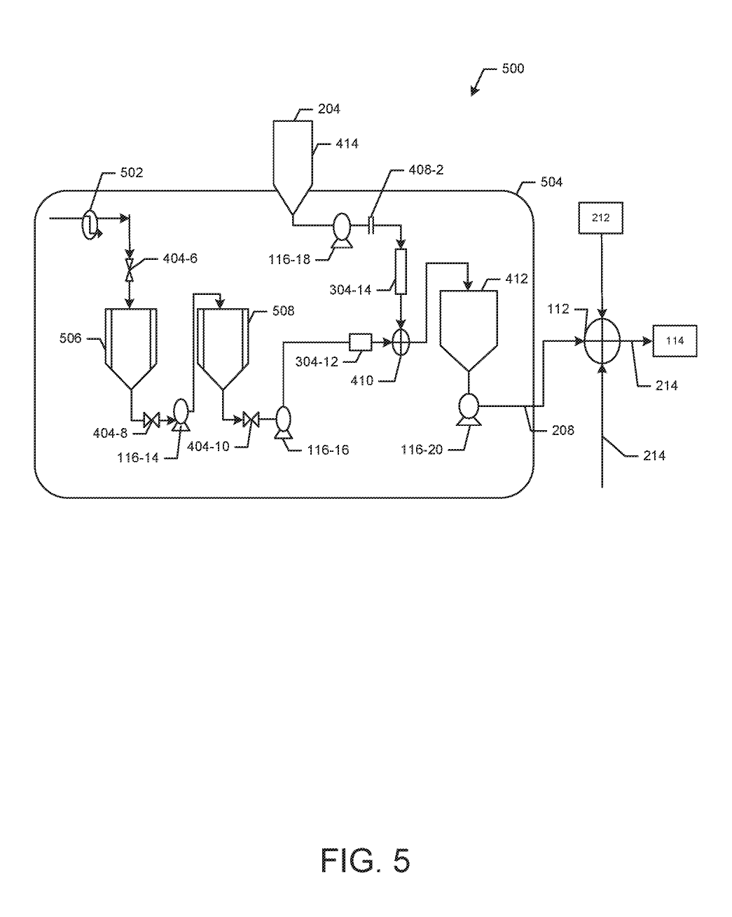

FIG. 5 illustrates another embodiment of manufacturing process 200 in system 500 in which embodiments of low solubility ingredient blending can be employed. As illustrated, a heat exchanger 502 can be employed to heat a solution of LSIs 202. Heat exchanger 502 can include any type of heater exchanger known in the art.

System 500 can also include a pilot skid 504 including one or more shut off valves 404, pumps 116, flanges 408, static mixers 410 and concentration meters 304. Pilot skid 504 can also include a batch tank 506, a feed tank 508 and buffer tank 412. Batch tank 506 and feed tank 508 can be of any size, build, and/or construction known in the art and can blend LSIs 202 in solution with solvent 204 via, for example, the one or more static mixers 410.

In one embodiment, system 500 can be used for continuous blending of mid-calorie and zero calorie formulas of beverage solution 214. In one possible embodiment, system 500 can be used to create concentrations of LSIs 202 in beverage solution 214 in the range of 250-700 ppm.

In one embodiment, heat exchanger 502 can be used to heat a solvent (and/or LSIs 202 in solution in the solvent) to an elevated temperature. This solvent (and/or solution of LSIs 202) can then be pumped to batch tank 506. In one possible aspect, the elevated temperature created by heat exchanger 502 can be chosen to increase a solubility limit of LSIs 202 either already in the solvent or to be added to the solvent later. Shut off valve 404-6 may be opened and closed to control a flow of the solvent (and/or LSIs 202 in the solvent) from being pumped into batch tank 506. At batch tank 506 a concentrated solution of LSIs 202 in the solvent can be formed. Shut off valve 404-8 can be closed while the concentrated solution is being formed by mixing LSIs 202 with the solvent at a desired temperature and concentration below the solubility limit of the LSIs 202 in the solvent).

When shut off valve 404-8 is open, the concentrated solution of LSIs 202 can be pulled to feed tank 508 by, for example, pump 116-14. In one possible aspect, when shut of valve 404-10 is closed, the concentrated solution of LSIs 202 can remain in feed tank 508.

When shut off valve 404-10 is open, pump 116-16 can pull the concentrated solution of LSIs 202 to static mixer 410. On the way, the concentrated solution of LSIs 202 can be measured by meter 304-12.

Similarly, solvent 204 may be drawn from solvent tank 414 through flange 408-2 by, for example, pump 116-18. Solvent 204 can be measured by meter 304-14 before arriving at static mixer 410 where solvent 204 and the concentrated solution of LSIs 202 are mixed to create first solution 208 which may be pumped to buffer 412. First solution 208 can then be drawn from buffer 412 by, for example, pump 116-20 to proportioner-carbonator 112 where it is mixed with beverage syrup 210 and carbonating agent 212 to form beverage solution 214, which can be pumped to filler 114.

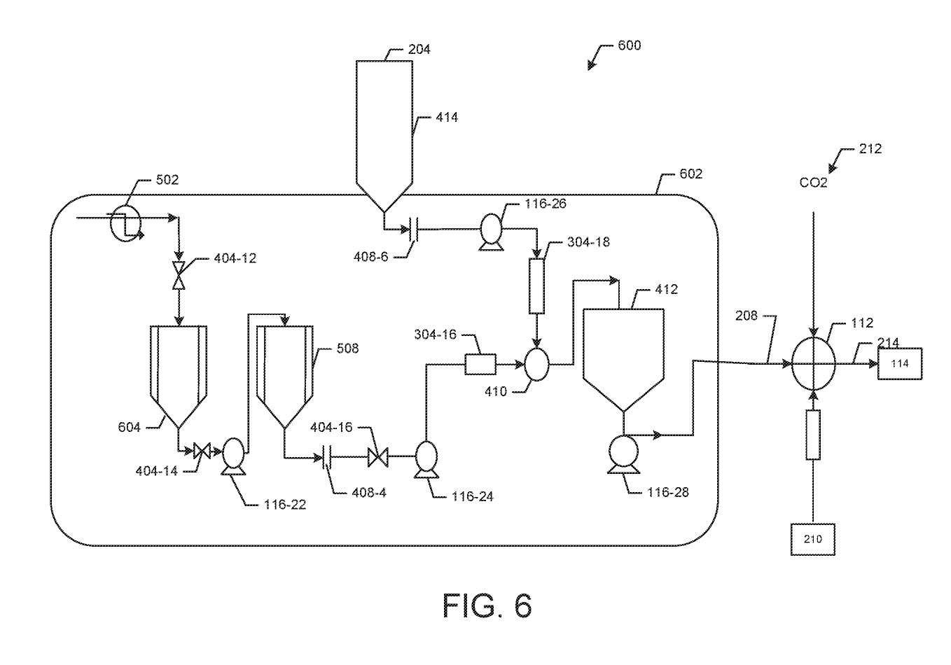

FIG. 6 illustrates another embodiment of manufacturing process 200 in system 600 in which embodiments of low solubility ingredient blending can be employed. As illustrated, a heat exchanger 502 can be employed to heat a solution of LSIs 202. Heat exchanger 502 can include any type of heater exchanger known in the art.

System 600 can also include a blend-in system 602 including one or more shut off valves 404, pumps 116, flanges 408, static mixers 410 and concentration meters 304. Blend-in system 602 can also include a concentrate tank 604, feed tank 508 and buffer tank 412. Concentrate tank 604 can be of any size, build, and/or construction known in the art and can introduce LSIs 202 in solution to solvent 204 via, for example, the one or more static mixers 410.

In one embodiment, blend-in system 602 is an inline system that utilizes ingredient water available downstream of syrup manufacturing to “blend” and mix LSIs 202.

For example, at station A, LSIs 202 are dissolved at an elevated temperature T (per unitized quantity) in concentrate tank 604. In one possible aspect, LSIs 202 can be in unitized concentrated powder form before being mixed with a solvent, such as treated water. The contents of concentrate tank 604 can be fed to feed tank 508, which can be called the run tank. In one possible aspect, feed tank 508 can feed the solution of LSIs 202 dissolved in a solvent (such as water, for example) downstream to be mixed and diluted with solvent 204 at a preset ratio of solvent 204 to LSI 202 at station B. One or more concentration meters 304 can be used to measure and/or control the flows of LSIs 202 and solvents (such as solvent 204) to ensure that the right ratio of solvent 204 to LSI 202 is achieved and maintained.

In one embodiment, a concentrate batch system (including, for example, blend-in system 602) equipped with a heat exchanger can allows for the indirect heating of solvent (such as, for example, treated water) to support dissolution of LSIs 202. In one possible aspect, one or more of concentrate tank 604 and feed tank 508 can be jacketed and insulated to help them maintain desired temperatures of their contents for an extended time.

At point C, the diluted LSIs 202 in first solution 208 are collected in buffer tank 412, which can serve as a “buffer” between the blend-in system 602 and the downstream proportioner-carbonator 112.

In one possible aspect, at proportioner-carbonator 112, first solution 208 can be further blended with beverage syrup 210 (per desired system throw ratio), and be carbonated to form beverage solution 214 which is ready to fill at filler 114.

In one embodiment, heat exchanger 502 can be used to heat a solvent (and/or LSIs 202 in solution in the solvent) to an elevated temperature. This solvent (and/or solution of LSIs 202) can then be pumped to concentrate tank 604. In one possible aspect the elevated temperature created by heat exchanger 502 can be chosen to increase a solubility limit of LSIs 202 either already in the solvent or to be added to the solvent later. Shut off valve 404-12 may be opened and closed to control a flow of the solvent (and/or LSIs 202 in the solvent) being pumped into concentrate tank 604. At concentrate tank 604 a concentrated solution of LSIs 202 in the solvent can be formed. Shut off valve 404-14 can be closed while the concentrated solution is being formed by mixing LSIs 202 with the solvent at a desired concentration below the solubility limit of the LSIs 202 in the solvent).

When shut off valve 404-14 is open, the concentrated solution of LSIs 202 can be pumped to feed tank 508 by, for example, pump 116-22. In one possible aspect, when shut of valve 404-16 is closed, the concentrated solution of LSIs 202 can remain in feed tank 508.

When shut off valve 404-16 is open, pump 116-24 can pull the concentrated solution of LSIs 202 to static mixer 410. One the way, the concentrated solution of LSIs 202 can be measured by meter 304-16.

Similarly, solvent 204 may be drawn from solvent tank 414 through flange 408-6 by, for example, pump 116-26. Solvent 204 can be measured by meter 304-18 before arriving at static mixer 410 where solvent 204 and the concentrated solution of LSIs 202 are mixed to create first solution 208 which may be pumped to buffer 412. First solution 208 may then be drawn from buffer 412 by, for example, pump 116-28 and pumped to proportioner-carbonator 112 where it can be mixed with beverage syrup 210 and carbonating agent 212 to form beverage solution 214, before being pumped to filler 114.

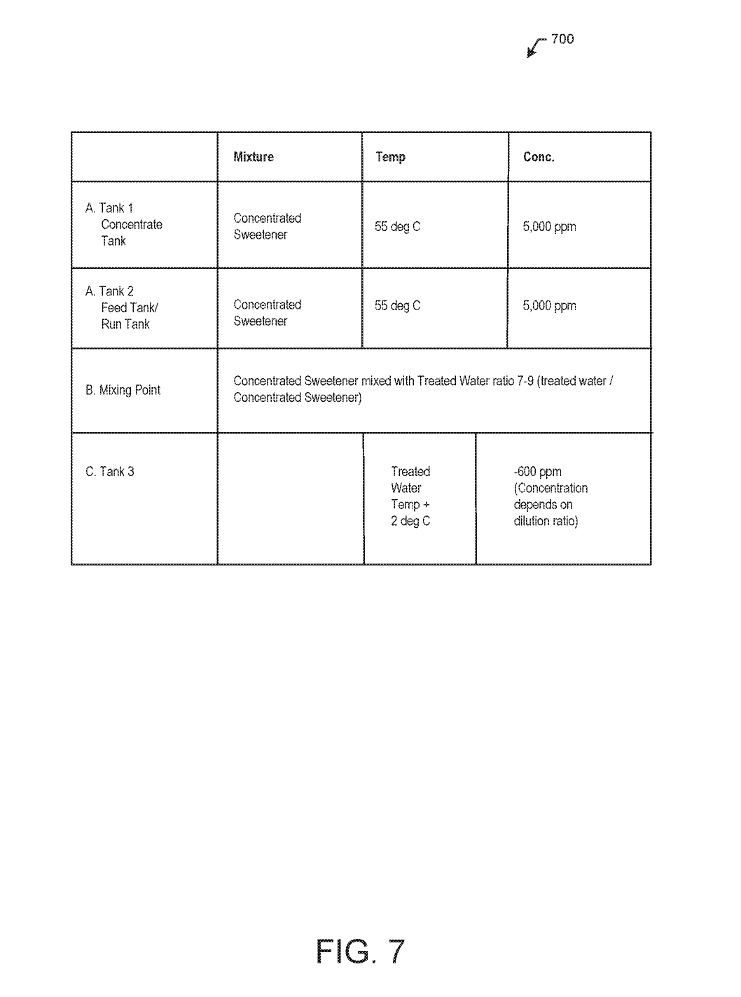

FIG. 7 illustrates example mixture specifications and results 700 associated with system 600 in accordance with various embodiments of low solubility ingredient blending. In the embodiment illustrated in FIG. 7, LSIs 202 include a concentrated sweetener, though as mentioned above, LSIs 202 can include any other substances having a low solubility.

In one possible embodiment, a concentration of LSIs 202 in solution at concentrate tank 604 at a temperature of 55 degrees Celsius can be 5000 parts per million (ppm). Similarly, a concentration of LSIs 202 in solution at feed tank 508 at a temperature of 55 degrees Celsius can be 5000 ppm. At a mixing point (e.g. static mixer 410) LSIs 202 can be mixed with treated water with a ratio of 7:9 for example (treated water to concentrated LSIs 202). At tank 412 at station C, the temperature of first solution 208 can be approximately 2 degrees above the temperature of the added solvent 204, when the solvent 204 is treated water. The concentration of LSIs in first solution 208 can be approximately 600 ppm, depending on the dilution ratio used.

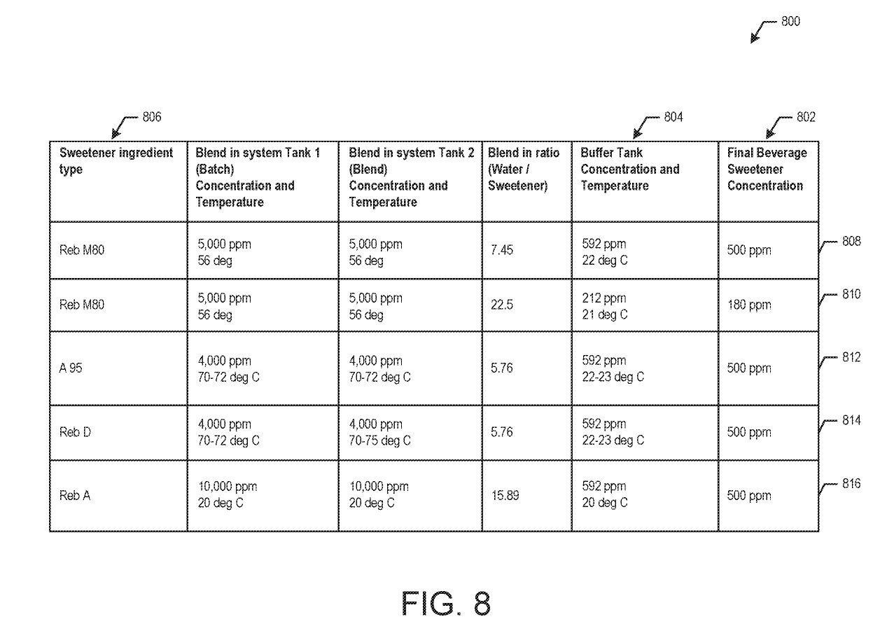

FIG. 8 illustrates more example mixture specifications and results 800 associated with system 600 in accordance with various embodiments of low solubility ingredient blending. As illustrated, concentration results 802, 804 for a variety of sweeteners 806 as LSIs 202, in the various tanks of system 600 are shown.

For example, as illustrated in row 808, when Reb M80 is used as LSI 202, the concentration of Reb M80 in solution at concentrate tank 604 and feed tank 508 can be approximately 5000 ppm at a solution temperature of 56 degrees Celsius. If solvent 204 is treated water, and the treated water is blended with the Reb M80 at a ratio of 7.45:1, then the concentration of Reb M80 in first solution 208 is 592 ppm with the temperature of first solution 208 being 22 degrees Celsius. The final concentration of Reb M80 in beverage solution 214 is 500 ppm.

Similarly, as illustrated in row 808, in another trial where Reb M80 is used as LSI 202, the concentration of Reb M80 in solution at concentrate tank 604 and feed tank 508 can be approximately 5000 ppm at a solution temperature of 56 degrees Celsius. If solvent 204 is treated water, and the treated water is blended with the Reb M80 at a ratio of 22.5:1, then the concentration of Reb M80 in first solution 208 is 212 ppm with the temperature of first solution 208 being 21 degrees Celsius. The final concentration of Reb M80 in beverage solution 214 is 180 ppm.

Additionally, as shown in line 812, in yet another trial where A95 is used as LSI 202, the concentration of A95 in solution at concentrate tank 604 and feed tank 508 can be approximately 4000 ppm at a solution temperature of 70-72 degrees Celsius. If solvent 204 is treated water, and the treated water is blended with the A95 at a ratio of 5.76:1, then the concentration of A95 in first solution 208 is 592 ppm with the temperature of first solution 208 being 22-23 degrees Celsius. The final concentration of A95 in beverage solution 214 is 500 ppm.

Additionally, as shown in line 814, in yet another trial where Reb D is used as LSI 202, the concentration of Reb D in solution at concentrate tank 604 and feed tank 508 can be approximately 4000 ppm at a solution temperature of 70-75 degrees Celsius. If solvent 204 is treated water, and the treated water is blended with the Reb D at a ratio of 5.76:1, then the concentration of Reb D in first solution 208 is 592 ppm with the temperature of first solution 208 being 22-23 degrees Celsius. The final concentration of Reb D in beverage solution 214 is 500 ppm.

Additionally, as shown in line 816, in yet another trial where Reb A is used as LSI 202, the concentration of Reb A in solution at concentrate tank 604 and feed tank 508 can be approximately 10,000 ppm at a solution temperature of 20 degrees Celsius. If solvent 204 is treated water, and the treated water is blended with the Reb A at a ratio of 15.89:1, then the concentration of Reb A in first solution 208 is 592 ppm with the temperature of first solution 208 being 20 degrees Celsius. The final concentration of Reb A in beverage solution 214 is 500 ppm.

The data given in FIG. 8 are for example trials. It will be understood that various other trials can also be used with other embodiments of low solubility ingredient blending in which other LSIs 202, solution temperatures in concentrate tank 604 and feed tank 508, blend ratios, etc. can be used.

It will be understood that in addition to carbonated beverages, embodiments of low solubility ingredient blending can also be used to create uncarbonated beverages including LSIs. For example, in the various embodiments described herein it may be possible to not add any CO₂ at the various proportioner/carbonators (such as proportioner/carbonaters 212) such that beverage solution 214 is uncarbonated. Alternately, or additionally, in place of proportioner/carbonators (such as proportioner/carbonaters 212), it may be possible to blend first solution 208 with beverage syrup 210 using a proportioner without an option of adding carbonation, such that beverage solution 214 is uncarbonated.

It will also be understood that the term LSIs as used herein can signify that several low solubility ingredients are used and/or a single low solubility ingredient is used.

### Example Computing Device

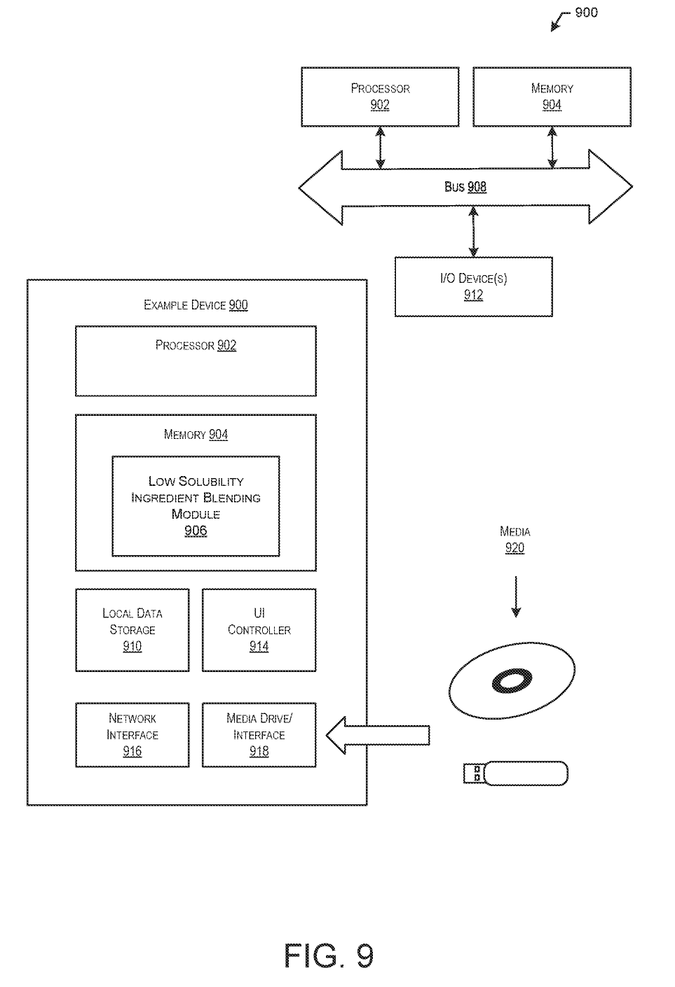

FIG. 9 illustrates an example device 900, with a processor 902 and memory 904 for hosting a low solubility ingredient blending module 906 configured to implement various embodiments of low solubility ingredient blending as discussed in this disclosure. Memory 904 can also host one or more databases and can include one or more forms of volatile data storage media such as random access memory (RAM), and/or one or more forms of nonvolatile storage media (such as read-only memory (ROM), flash memory, and so forth).

Device 900 is one example of a computing device or programmable device, and is not intended to suggest any limitation as to scope of use or functionality of device 900 and/or its possible architectures. For example, device 900 can comprise one or more computing devices, programmable logic controllers (PLCs), etc.

Further, device 900 should not be interpreted as having any dependency relating to one or a combination of components illustrated in device 900. For example, device 900 may include one or more of a computer, such as a laptop computer, a desktop computer, a mainframe computer, etc., or any combination or accumulation thereof.

Device 900 can also include a bus 908 configured to allow various components and devices, such as processors 902, memory 904, and local data storage 910, among other components, to communicate with each other.

Bus 908 can include one or more of any of several types of bus structures, including a memory bus or memory controller, a peripheral bus, an accelerated graphics port, and a processor or local bus using any of a variety of bus architectures. Bus 908 can also include wired and/or wireless buses.

Local data storage 910 can include fixed media (e.g., RAM, ROM, a fixed hard drive, etc.) as well as removable media (e.g., a flash memory drive, a removable hard drive, optical disks, magnetic disks, and so forth).

One or more input/output (I/O) device(s) 912 may also communicate via a user interface (UI) controller 914, which may connect with I/O device(s) 912 either directly or through bus 908.

In one embodiment, a network interface 916 may communicate outside of device 900 via a connected network, and in some embodiments may communicate with hardware, such as concentration meters 304 and/or a control system associated with the various systems illustrated in FIGS. 1-6.

In one embodiment, external equipment, including computers, concentration meters 304, a control system associated with the various systems illustrated in FIGS. 1-6, etc., may communicate with device 900 as input/output device(s) 912 via bus 908, such as via a USB port, for example.

A media drive/interface 918 can accept removable tangible media 920, such as flash drives, optical disks, removable hard drives, software products, etc. In one embodiment, logic, computing instructions, and/or software programs comprising elements of low solubility ingredient blending module 906 may reside on removable media 920 readable by media drive/interface 918.

In one possible embodiment, input/output device(s) 912 can allow a user to enter commands and information to device 900, and also allow information to be presented to the user and/or other components or devices. Examples of input device(s) 912 include, for example, sensors, a keyboard, a cursor control device (e.g., a mouse), a microphone, a scanner, and any other input devices known in the art. Examples of output devices include a display device (e.g., a monitor or projector), speakers, a printer, a network card, and so on.

Various processes of low solubility ingredient blending module 906 may be described herein in the general context of software or program modules, or the techniques and modules may be implemented in pure computing hardware. Software generally includes routines, programs, objects, components, data structures, and so forth that perform particular tasks or implement particular abstract data types. In one embodiment, these modules and techniques may be stored on or transmitted across some form of tangible computer-readable media. Computer-readable media can be any available data storage medium or media that is tangible and can be accessed by a computing device. Computer readable media may thus comprise computer storage media. “Computer storage media” designates tangible media, and includes volatile and non-volatile, removable and non-removable tangible media implemented for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible medium which can be used to store the desired information, and which can be accessed by a computer.

In one embodiment, device 900, or a plurality thereof, can be employed in conjunction with the various systems illustrated in FIGS. 1-6.

Although a few example embodiments have been described in detail above, those skilled in the art will readily appreciate that many modifications are possible in the example embodiments without materially departing from this disclosure. Accordingly, such modifications are intended to be included within the scope of this disclosure as defined in the following claims. Moreover, embodiments may be performed in the absence of any component not explicitly described herein.

In the claims, means-plus-function clauses are intended to cover the structures described herein as performing the recited function and not just structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

### Systems and Methods for Dissolving Low-Solubility Ingredients

In the previous discussion, it was noted that heaters such as heat exchanger 502 can be used to heat a solvent (and/or LSIs 202 in solution in the solvent) to an elevated temperature. This solvent (and/or solution of LSIs 202) can then be pumped to batch tank 506 and used to increase the solubility of the low-solubility ingredients. Surprisingly, it has been discovered that such heated solutions maintain an increased solubility when cooled, for longer than expected. Thus, in some embodiments, low-solubility ingredients may first be dissolved in a preheated solvent having a first temperature, and then cooled to a second temperature while preparing or mixing the first solution. In some embodiments, the mixing may be high shear mixing.

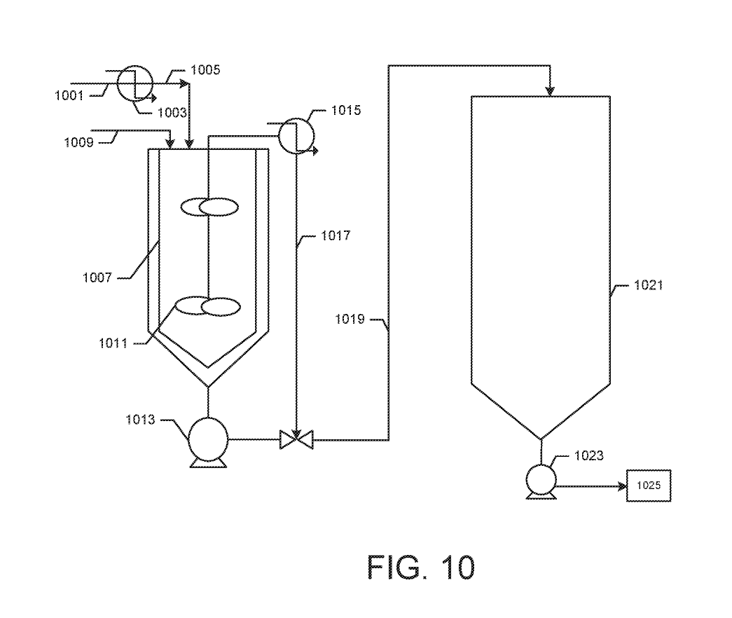

FIG. 10 illustrates an embodiment of a manufacturing system 1000 for blending a low solubility ingredient into a beverage solution. In this embodiment, a solvent stream 1001 is heated by heater 1003 to create a heated solvent stream 1005, which is added to a preblend tank 1007 with one or more low solubility ingredients (LSIs) 1009. The preblend tank 1007 may contain one or more impellers 1011. In some embodiments, the impellers are designed to mix the contents of the preblend tank 1007 at high shear. That is, in some embodiments, the impellers are designed to suspend and impart motion to any undissolved LSIs 1009 in the heated solvent as a slurry within the preblend tank 1007. In this way, the pre-blend tank functions as a mixer. The preblend tank 1007 may operate as a batch mixer or as a continuous mixer.

The preblend tank may be connected to one or more pumps 1013 which may remove the contents of the preblend tank 1007. In some embodiments, a portion of the LSI solution may be removed by pump 1013, and a portion of the LSI solution may be cooled by cooler 1015 to create a cooled LSI solution stream 1017 which has a second temperature. In some embodiments, all of the LSI solution is pumped by pump 1013 through cooler 1015 to create a cooled LSI solution stream 1017 having a second temperature. In some embodiments, the pump 1013 may pump a portion of the LSI solution out of the tank and combine it with the cooled LSI solution stream 1017 to form a combined stream 1019. In some embodiments, the cooler may be integrated with a second mixer (not shown), so that the LSI solution is continuously mixed while it is being cooled to a second temperature.

The combined stream 1019 (or cooled stream 1017) may then be added to a syrup tank 1021. The syrup tank may contain a beverage syrup made by mixing one or more preblend batches, as discussed above. The syrup tank may contain one or more impellers, spargers, or the like, to mix the combined stream 1019 with a beverage syrup to form a beverage solution. The beverage solution may then be pumped from the syrup tank 1021 by pump 1023 to a propotioner/carbonator 1025, and a bottler/filler to form finished beverages as described above.

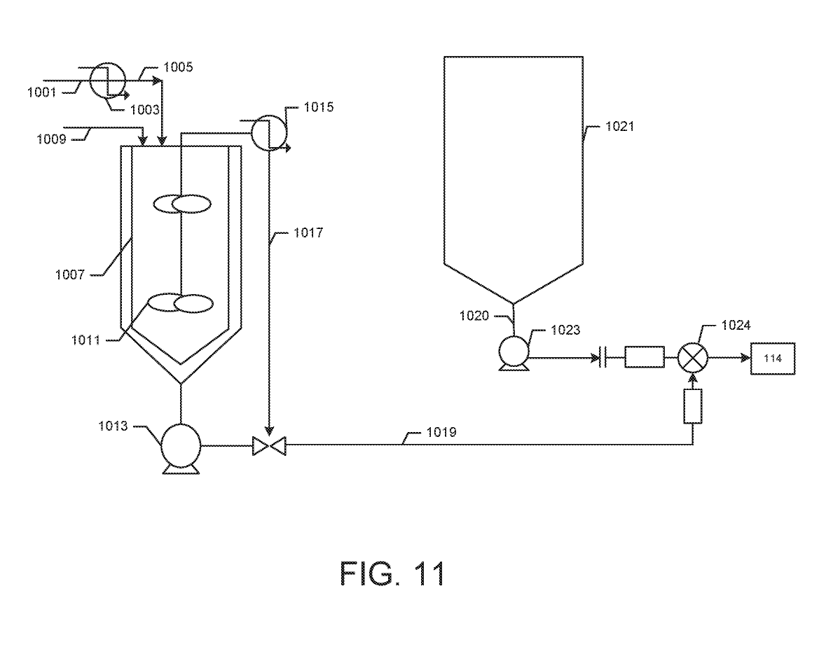

FIG. 11 illustrates another embodiment of a manufacturing system 1100 for blending a low solubility ingredient into a beverage solution. In this embodiment, a solvent stream 1001 is heated by heater 1003 to create a heated solvent stream 1005, which is added to a preblend tank 1007 with one or more low solubility ingredients (LSIs) 1009. The preblend tank 1007 may contain one or more impellers 1011. In some embodiments, the impellers are designed to mix the contents of the preblend tank 1007 at high shear. That is, in some embodiments, the impellers are designed to suspend any undissolved LSIs 1009 in the heated solvent as a slurry within the preblend tank 1007. In this way, the pre-blend tank functions as a mixer. The preblend tank 1007 may operate as a batch mixer or as a continuous mixer.

The preblend tank may be connected to one or more pumps 1013 which may remove the contents of the preblend tank 1007. In some embodiments, a portion of the LSI solution may be removed by pump 1013, and a portion of the LSI solution may be cooled by cooler 1015 to create a cooled LSI solution stream 1017 which has a second temperature. In some embodiments, all of the LSI solution is pumped by pump 1013 through cooler 1015 to create a cooled LSI solution stream 1017 having a second temperature. In some embodiments, the pump 1013 may pump a portion of the LSI solution out of the tank and combine it with the cooled LSI solution stream 1017 to form a combined stream 1019. In some embodiments, the cooler may be integrated with a second mixer (not shown), so that the LSI solution is continuously mixed while it is being cooled to a second temperature.

The combined stream 1019 (or cooled stream 1017) may then be combined with a stream of beverage syrup 1020 from syrup tank 1021. The stream of beverage syrup 1020 may contain a beverage syrup made by mixing one or more preblend batches, as discussed above. The stream of beverage syrup 1020 may be pumped by pump 1023, and may be combined with the combined stream 1019 (or cooled stream 1017) in a mixer 1024, for example, a static mixer, to form a beverage solution. The beverage solution may then be sent to a propotioner/carbonator 1025, and a bottler/filler to form finished beverages as described above. In embodiments, a buffer 412, typically with an associated pump, can be used between the mixer (e.g. static mixer) proportioner-carbonator 112 where thorough mixing occurs.

In some embodiments, the heated solvent stream 1005 is heated to a temperature of from about 20° C. to about 80° C., for example about 20° C., about 25° C., about 30° C., about 35° C., about 40° C., about 45° C., about 50° C., about 55° C., about 60° C., about 65° C., about 70° C., about 75° C., about 80° C., or any range therebetween.

In some embodiments, the heated solvent stream 1005 and LSI 1009 are mixed in the preblend tank 1007 until the LSI dissolves in the solvent. For example, in some embodiments the heated solvent stream 1005 and LSI 1009 are mixed in the preblend tank 1007 from about 20 minutes to about 1 hour, for example for about 20 minutes, for about 25 minutes, for about 30 minutes, for about 35 minutes, for about 40 minutes, for about 45 minutes, for about 50 minutes, for about 55 minutes, for about 1 hour, or any range therebetween. In some embodiments for example, the solution created in the preblend tank 1007 can contain LSI 1009 at a concentration of from about 0.5 wt % to about 0.8 wt %, for example about 0.5 wt %, about 0.6 wt %, about 0.7 wt %, or about 0.8 wt %.

In some embodiments, the second temperature is from about 0° C. to about 30° C., for example about 0° C., about 5° C., about 10° C., about 15° C., about 20° C., about 25° C., about 30° C., or any ranges therebetween.

In some embodiments, the LSIs are present in the final beverage solution at a concentration of from about 0.20 wt % to amount 0.30 wt %, for example about 0.2 wt %, 0.25 wt %, about 0.3 wt %, or any range therebetween.

In some embodiments, the LSIs are present in the final beverage solution at a concentration of from about 0.20 wt % to amount 0.30 wt %, for example about 0.2 wt %, 0.25 wt %, about 0.3 wt %, or any range therebetween.

### EXAMPLES

The invention is further illustrated by the following examples, which are not to be construed in any way as imposing limitations to the scope of this invention. Various other aspects, embodiments, modifications, and equivalents thereof which, after reading the description herein, can suggest themselves to one of ordinary skill in the art without departing from the spirit of the present invention or the scope of the appended claims.

### Example 1: Lab Reb M Solutions

First, distilled water was heated to between 55 and 70° C. in a graduated cylinder. Next, Reb M crystalline was stirred with a magnetic stir bar until dissolved in the heated water to create a solution of 0.5 wt %-0-0.7 wt % Reb M in water. Next, the Reb M solution was allowed to cool while being stirred until it reached an ambient temperature (less than 30° C.).

Next, the Reb M solution was separated into three separate samples. Each of these samples was further diluted with distilled water to form a 0.2 wt % Reb M solution, a 0.25 wt % Reb M solution, and a 0.30 wt % Reb M solution. Each of these solutions was left in a graduated cylinder and was visually observed to determine stability. The 0.2 wt % Reb M solution was found to be stable for 8 days, the 0.25 wt % Reb M solution was found to be stable for 4 days, and the 0.30 wt % Reb M solution was found to be stable for 3 days.

### Example 2: Pilot Reb M Solutions

Based on the favorable results of the lab tests, several pilot trials were conducted. First, samples of treated water was heated to 55 and 70° C. in a continuously stirred tank. Next, Reb M crystalline was added and stirred in the continuously stirred tank until dissolved in the heated water to create solutions of 0.5 wt % and 0.67 wt % Reb M in the heated water respectively. The Reb M solutions were then allowed to cool while being stirred until it reached an ambient temperature (less than 30° C.).

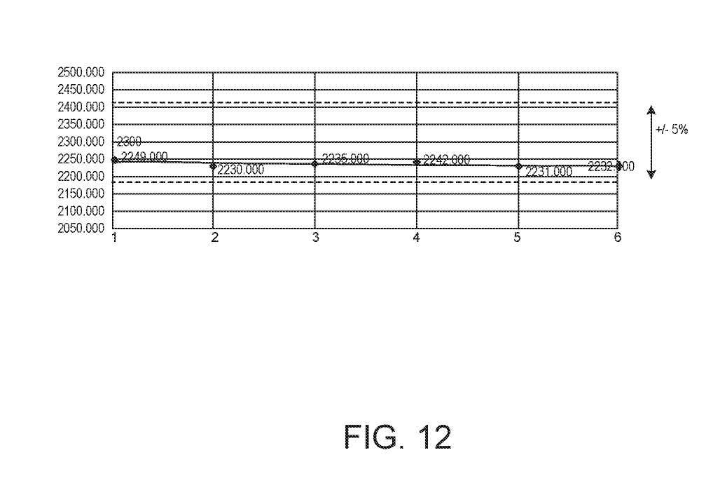

Next, additional water was added to the 0.5 wt % Reb M solution and stirred at a speed of 40 Hz to create two separate solutions—a 0.25 wt % Reb M solution and a 0.3 wt % Reb M solution. The 0.25 wt % Reb M solution was left in the tank and samples were taken from the top and bottom of the tank, and the concentration of Reb M (also referred to as Rebiana) was measured immediately after the syrup was formed, 24 hours later, and 72 hours later. The results of these measurements are shown in FIG. 12. The green line represents the estimated target Rebiana concentration of 2300 ppm, and the yellow dashed lines represent values +/−5% of the estimated target value. As can be seen from this graph, the actual concentration of Reb M/Rebiana in these samples fell within 3% of the estimated target value for all values measured throughout the 72 hour period.

As can be seen from FIG. 12, initially (time=0) the concentration of Rebiana in the sample taken from the top of the tank was very close to the concentration of Rebiana in the sample taken from the bottom of the tank—2249 ppm and 2230 ppm, respectively. 24 hours later, new samples were taken from the top and bottom of the tank. These samples showed that the concentration of Rebiana in the top of the tank decreased slightly to 2235 ppm and the concentration of Rebiana in the bottom of the tank increased somewhat to 2242 ppm. The decrease in concentration of Rebiana in the top of the tank and increase in concentration of Rebiana in the bottom of the tank are consistent with the Rebiana settling to the bottom of the solution over time. Next, 72 hours after the Reb M solution was initially created, samples were again taken from the top and bottom of the tank. These samples showed that the concentration of Rebiana in the top of the tank decreased once again, to 2231 ppm, and that the concentration of Rebiana in the bottom of the tank decreased to 2232 ppm. Once again, this is consistent with the Rebiana settling to the bottom of the solution and slowly but eventually precipitating out of the Reb M solution.

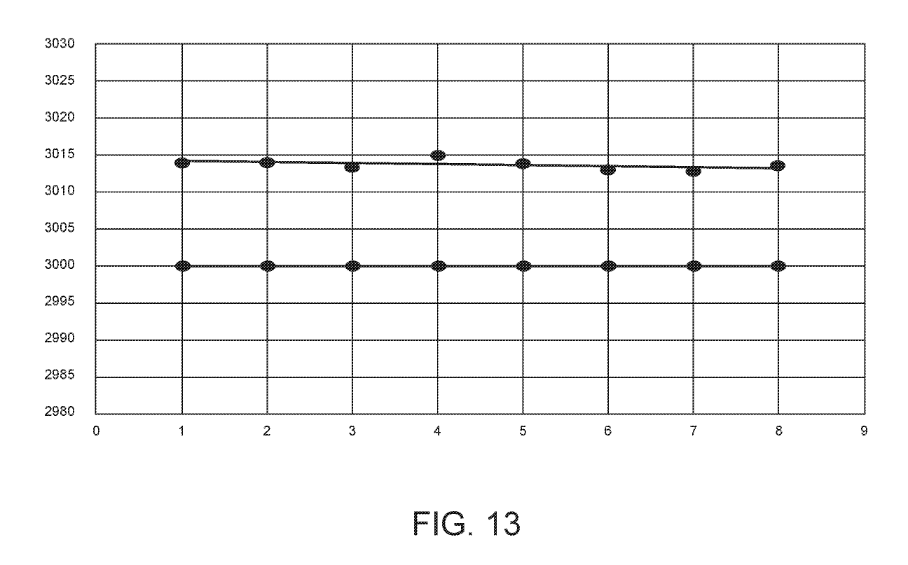

Similarly, the 0.3 wt % Reb M solution was left in the tank and samples were taken from the top and bottom of the tank, and the concentration of Rebiana was measured immediately after the syrup was formed, and three times over four days. The results of these measurements are shown in FIG. 13. The green (bottom) line represents the estimated target Rebiana concentration of 3000 ppm. The blue datapoints show the measured concentrations of Reb M, and the blue line is a linear best fit of this data.

Measurements 1, 3, 5, and 7 were taken from the top of the tank. Measurements 2, 4, 6, and 8 were taken from the bottom of the tank. As can be seen from this data, the concentration of Reb M in the top of the tank generally decreased over time, while the concentration of Reb M in the bottom of the tank initially increased and then decreased from the initial concentration. This is consistent with the Reb M slowly settling to the bottom of the solution, and eventually precipitating out of the solution. However, as can be seen from this data, the concentration of RebM in the top and bottom of the tank varied less than 3 ppm across the 4 days while concentration was measured, indicating that the solution was very stable.

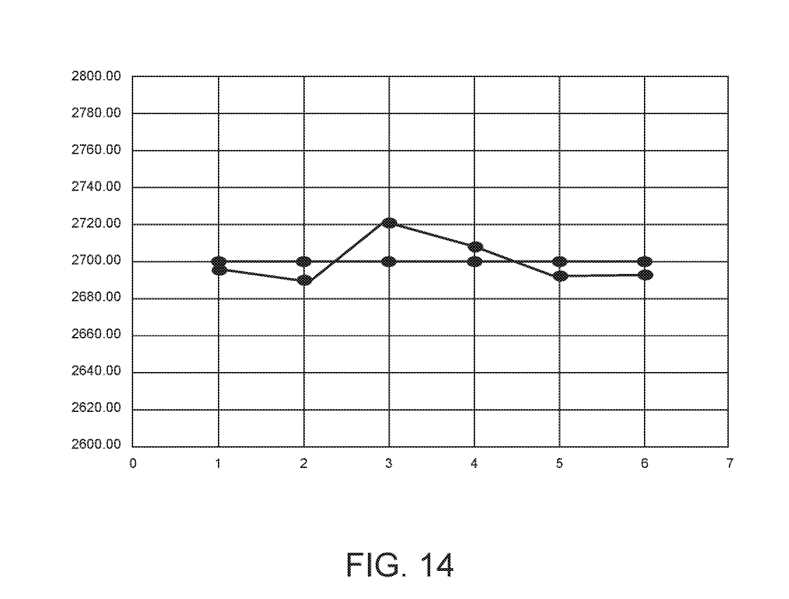

Next, the additional water was added to the 0.67 wt % Reb M solution and stirred at a speed of 40 Hz to create a 0.27 wt % Reb M solution. The 0.27 wt % Reb M solution was left in the tank and samples were taken from the top and bottom of the tank, and the concentration of Rebiana was measured immediately after the syrup was formed, and two times over four days. The results of these measurements are shown in FIG. 14. The green (straight) line represents the estimated target Rebiana concentration of 2700 ppm. The more irregular or variable line illustrated by the blue datapoints show the measured concentrations of Reb M.

Measurements 1, 3, and 5 were taken from the top of the tank. Measurements 2, 4, and 6 were taken from the bottom of the tank over the days shown.

1. A method of blending a low solubility ingredient into a beverage solution comprising:
dissolving the low solubility ingredient in a preheated solvent to provide a first solution;
combining one or more pre-blend batches to form a beverage syrup; and
combining the first solution with the beverage syrup to form a beverage solution.

2. The method of claim 1, wherein dissolving the low solubility ingredient in a preselected solvent to provide the first solution comprises:
combining the low solubility ingredient with the preheated solvent to provide the first solution wherein the preheated solvent has a first temperature; and
cooling the first solution to a second temperature while stirring the first solution.

3. The method of claim 1, wherein the preselected solvent comprises water.

4. The method of claim 1, further comprising: monitoring a concentration of the low solubility ingredient in the first solution.

5. The method of claim 1, wherein the low solubility ingredient is present in the first solution at a concentration of about 0.4% to amount 1.2% by weight of the first solution.

6. The method of claim 1, wherein the low solubility ingredient is present in the first solution at a concentration of from about 0.5% to about 0.7% by weight of the first solution.

7. The method of claim 1, wherein the low solubility ingredient is present in the beverage solution at a concentration of about 0.20% to amount 0.30% by weight of the beverage solution.

8. The method of claim 2, wherein the first temperature is from about 20° C. to about 80° C.

9. The method of claim 2, wherein the first temperature is from about 55° C. to about 70° C.

10. The method of claim 2, wherein the second temperature is from about 0° C. to about 30° C.

11. The method of claim 2, wherein the second solution is a beverage.

12. The method of claim 2, further comprising mixing a diluent with the beverage solution to form a beverage.

13. The method of claim 12, wherein the diluent is water or carbonated water.

14. The method of claim 1, wherein the first solution is stable for about 3 days to about 8 days at ambient temperature.

15. The method of claim 1, wherein the low solubility ingredient is selected from Reb M, Reb A, Reb D, Reb M80, or A95.

16. The method of claim 1, wherein the low solubility ingredient is Reb M.

17. A method of blending a low solubility ingredient into a beverage solution comprising:
combining the low solubility ingredient with a preheated solvent in a first tank to provide a first solution wherein the preheated solvent has a first temperature;
cooling the first solution to a second temperature to form a cooled solution while stirring the first solution;
transferring the cooled solution to a second tank;
combining the cooled solution with a second solvent to form a second solution;
transferring the second solution to a buffer tank;
combining one or more pre-blend batches to form a beverage syrup; and
combining the second solution with the beverage syrup to form a beverage solution.

18. A mixing apparatus configured to facilitate blending of a low solubility ingredient into a beverage solution, comprising:
a controller operable to:
monitor a concentration of the low solubility ingredient in a solution with a solvent; and
add more solvent when the concentration of the low solubility ingredient approaches a preset level.
